(19) United States
(12) Patent Application Publication
(10) Pub. No.: US 2017/0193484 A1
(43) Pub. Date: Jul. 6, 2017

(54) METHOD AND SYSTEM FOR SECURE CONSUMER IDENTIFICATION

(71) Applicant: MasterCard International Incorporated, Purchase, NY (US)

(72) Inventors: Cindi Pitz, Stormville, NY (US); David Weis, Boerne, TX (US); Christopher Bracconeri, Tuckahoe, NY (US)

(21) Appl. No.: 14/985,815

(22) Filed: Dec. 31, 2015

(51) Int. Cl. G06Q 20/22; G06Q 20/40

(52) U.S. Cl. CPC G06Q 20/227; G06Q 20/405

(57) ABSTRACT

Methods and systems may receive transaction information associated with a cardholder's multi-account payment identifier, the multi-account payment identifier being linked to: (i) a credit card account, (ii) a debit card account, (iii) a bank account, (iv) a pre-paid account, (v) a virtual wallet, and/or (vi) a retailer-branded account. A segmentation category of the cardholder may be determined based on prior transactions made with the multi-account payment identifier. The transaction information may be analyzed in substantially real time in accordance with at least one potential transaction rule associated with the cardholder. Based on the segmentation category and the analysis of the transaction information, a recommended account linked to the multi-account payment identifier may be determined, and it may be arranged for a recommendation message, including an indication of the recommended account, to be transmitted to the cardholder in substantially real time.

### BACKGROUND

A person may be associated with a number of different payment accounts and/or different types of payment accounts. For example, a person might have both a debit card account, a pre-paid payment card, and several different credit card accounts. Moreover, some smartphone virtual or mobile “wallet” applications can be associated with multiple payment accounts. The use of such wallet applications, however, may require costly merchant hardware upgrades. In addition, wallet applications may confuse people if different wallet applications are only available in connection with different sets of merchants, particular types of payment accounts, etc. Further note it can be difficult for a person to determine which payment account he or she should use for a particular purchase (e.g., based on available funds, loyalty programs, etc.).

Therefore, it would be desirable to provide improved methods and apparatus to efficiently facilitate and process card transactions associated with multiple payment accounts.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 illustrates linked payment accounts according to some embodiments herein;

FIG. 2 is an illustrative front view depiction of a payment card, according to some embodiments herein;

FIG. 3 is an illustrative back view depiction of a payment card, according to some embodiments herein

FIG. 4 is an illustrative depiction of a contactless payment card, according to some embodiments herein;

FIG. 5 is a block diagram of a mobile device, in accordance with some embodiments herein;

FIG. 6 is an illustrative depiction of a system, according to one embodiment herein;

FIG. 7 is a flow diagram of a process, according to some embodiments herein;

FIG. 8 is schematic block diagram of an apparatus, according to some embodiments herein;

FIG. 9 is a portion of a tabular multi-account payment identifier database, according to some embodiments herein;

FIG. 10 is a flow diagram of a process associated with a recommendation of a new payment account, according to some embodiments herein; and

FIG. 11 is a flow diagram of a process including an arrangement for payments, according to some embodiments herein.

### DETAILED DESCRIPTION

In general, and for the purpose of introducing concepts of embodiments of the present disclosure, a payment vehicle refers to, in general, a payment device of any embodiment (e.g., a card, mobile telephone, a key fob, etc.) that may be used to store, present, and represent a Primary Account Number (“PAN”) that may be used in a payment or purchase transaction. As used herein, the terms purchase transaction and payment transaction or simply transaction may be used interchangeably unless stated otherwise. In general, the purchase transactions herein refer to card present and card not present transactions, including for example e-commerce transactions.

In some aspects, one or more services may be provided to an entity that uses a payment vehicle in, for example, a purchase transaction. For example, the cardholder of a credit card may be enrolled in a loyalty program of a financial institution, a retailer, or a third party and earn loyalty points when using the credit card for certain transactions.

An entity, such as a person or business enterprise, may be associated with a number of different payment accounts and/or different types of payment accounts. For example, a person might have both a debit card account, a pre-paid payment card, and several different credit card accounts. Moreover, some smartphone virtual or mobile “wallet” applications can be associated with multiple payment accounts. The use of such wallet applications, however, may require costly merchant hardware upgrades, such as new Point Of Sale (“POS”) terminals. In addition, wallet applications may confuse people if different wallet applications are only available in connection with different sets of merchants, particular types of payment accounts, etc. Further note it can be difficult for a person to determine which payment account he or she should use for a particular purchase (e.g., based on available funds, loyalty programs, etc.).

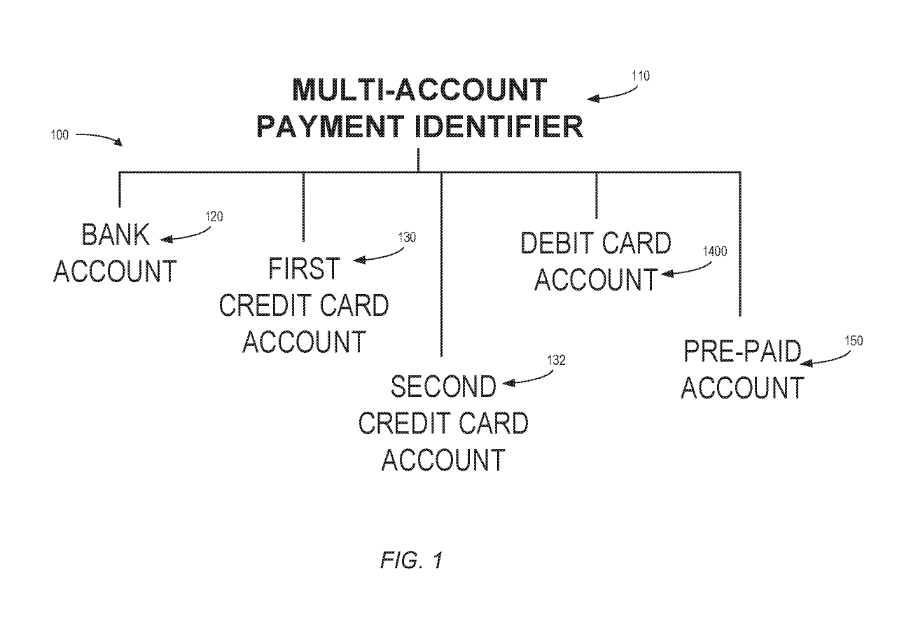

According to some embodiments described here, multiple payment accounts may be linked to a single “master” account. For example, FIG. 1 illustrates 100 linked payment accounts according to some embodiments herein. In particular, a master multi-account payment identifier 110 may be provided. The multi-account payment identifier 110 may, for example, be linked to a bank account 120, multiple credit card accounts 130, 132, a debit card account 140, and/or a pre-paid account 150. Note that the illustration 100 of FIG. 1 is provided only as an example, and the multi-account payment identifier 110 could be associated with any number of combination of credit card accounts, debit card accounts, bank accounts, pre-paid accounts, virtual wallets, retailer-branded accounts, etc. According to some embodiments, a single payment account might be associated with a number of different multi-account payment identifiers.

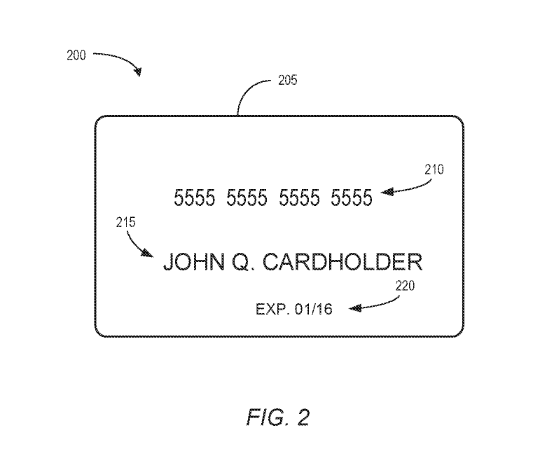

FIG. 2 is an illustrative depiction of a frontal view of a multi-account payment card in accordance with some embodiments herein. By way of example, FIG. 2 is an illustrative frontal view of a payment card 200 having a having a substantially planar card-shaped body 205, according to some embodiments of the present disclosure. In particular, illustrated is a substantially card-shaped body 205 that may comprise an International Standards Organization/International Electrotechnical Commission (“ISO/IEC”) 7810 ID-1 sized card having a thickness of 0.76 mm (0.030 in) and a top area of 85.60×53.98 mm (3.370×2.125 in) with rounded corners having a radius of 2.88-3.48 mm. However, this size and shape are provided for illustrative purposes only. Those skilled in the art, upon reading the present disclosure, will appreciate that other shapes, form factors, sizes, and configurations of card-shaped or other shaped bodies may be used in conjunction with embodiments of the present disclosure.

The card body 205 may be formed of one or more sheets of plastic or other materials. The card body 205 might be formed of different materials. It is noted that any of the embodiments described herein may be formed of other materials having appropriate properties compatible with this disclosure, such as strength, luminosity, and/or flexibility.

According to some embodiments, the card 200 further includes a multi-account payment identifier 210 that is embossed or printed on a face of the card. Note that the multi-account payment identifier may, according to some embodiments, comprise a Primary Account Number (“PAN”) that can be processed by existing credit card payment systems. In some embodiments, the card 200 may further include a cardholder's name 215 and an expiration date 220 that are embossed or printed on the front of the card 200.

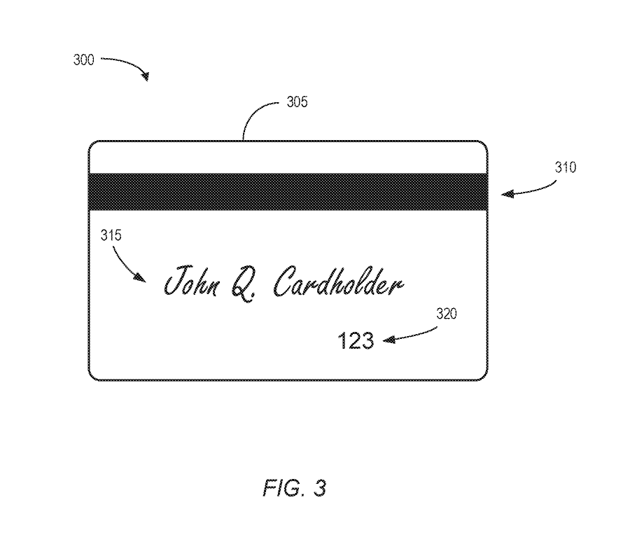

FIG. 3 is an illustrative depiction of a back view of a card 300, in accordance with some embodiments herein. In some embodiments, the card 300 corresponds to the card depicted in FIG. 2. The card body 305 includes a magnetic stripe 310 having data encoded therein. The data stored within the magnetic stripe may include payment credentials such as, but not limited to, the multi-account payment identifier of the cardholder and security code(s). The particular format of data on the stripe 310 is not limited to a specific configuration in some embodiments herein. For example, the multi-account payment identifier may be encrypted in some instances. In some embodiment, the format or configuration of the multi-account payment identifier (e.g., length, syntax, etc.) is compatible with existing card manufacturing, encoding, and processing systems and methods.

The card 300 may further include a signature block wherein the cardholder signs card 300 with their signature 315. In some embodiments, a security feature such as a security code 320 is embossed on card's back face 305. In some instances, the security code 320 may be a two or three digit or any other number of digits security code.

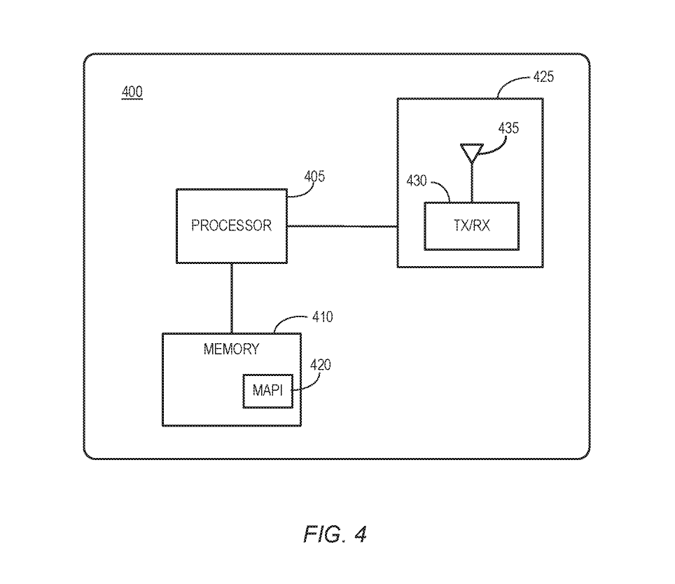

FIG. 4 is an illustrative schematic block diagram of a payment vehicle in accordance with some embodiments herein. In particular, FIG. 4 is a schematic diagram of a contactless, proximity payment device 400 according to some embodiments. The proximity payment device 400 may be sized and shaped like a conventional credit card or debit card, and may be primarily constructed of plastic or a composite material. The proximity payment device 400 includes a processor 405, at least one storage device 410, and a wireless communication interface 425. The storage device 410 may comprise any appropriate information storage device, including combinations of storage devices, for example, integrated circuits and/or semiconductor memory devices (such as Random Access Memory (“RAM”) devices and Read Only Memory (“ROM”) devices), flash memory, and a solid state drive. The storage device 410 may be any suitable computer readable medium and/or any form of non-transitory computer readable media capable of storing data, and in some implementations may also be capable of storing or configured to store computer instructions and/or application programs that are executable by a processor.

In some embodiments, the storage device 410 may include memory space that stores Multi-Account Payment Identifier (“MAPI”) 420. The storage device 410 may also be configured to store additional other information that may be used in transactions, either financial and/or non-financial transactions. In some embodiments, the storage device 410 may store one or more application programs and/or computer-readable instructions configured to instruct processor 405 to perform functions in accordance with one or more processes, including but not limited to those disclosed herein. In some embodiments, processor 405 may be a secure microcontroller. In some aspects, the MAPI 420 may be contained within one or more secure storage portions of storage device 410. The processor 405 may be configured to execute one or more pre-defined mobile device transaction programs or applications stored within the storage device 410, such as for example applications or “apps” configured to facilitate participation in a loyalty program or service, a virtual wallet, a MAPI environment, etc.

A wireless communication interface 425 allows the proximity payment device 400 to transmit and/or to receive signals. The signals transmitted by the wireless communication interface 425 may include the MAPI 420 and/or other information stored in the memory or storage device 410. The signals received by the wireless communication interface 425 may include an interrogation signal, a power signal and/or other signals. In some embodiments, the wireless communication interface 425 may be configured to allow the proximity payment device 400 to operate in accordance with, for example, the well known standard for proximity payment devices that has been promulgated by MasterCard International Incorporated, the assignee hereof, and is referred to as “PayPass™”.

In some embodiments, a wireless communication interface 425 includes transmit/receive circuitry 430 and an antenna 435. The antenna 435 may be configured to transmit and receive Radio Frequency (“RF”) and/or other communication signals and may comprise a loop antenna and/or any other suitable device to facilitate reception and transmission of the signals. The transmit/receive circuitry 430 may be coupled between the antenna 435 and the processor 405.

In operation, wireless signals (for example, RF signals) may be received by the antenna 435 and supplied to the transmit/receive circuitry 430, which in response may provide signals that are supplied to the processor 405. The processor 405 may provide signals that are supplied to the transmit/receive circuitry 430, which in response may provide signals that are supplied to the antenna 435 for wireless transmission to, for example, a proximity reader device associated with a POS terminal.

In some embodiments, wireless communication by card 400 may be based on an RF Identification (“RFID”) Integrated Circuit (“IC”), Near Field Communication (“NFC”), and other communication technologies.

In some embodiments, the contactless proximity payment device 400 of FIG. 4 may be combined with other features of other payment vehicle devices. For example, the contactless card proximity payment device 400 of FIG. 4 may include a magnetic stripe such as that disclosed in FIG. 1. Such a device may be referred to as a hybrid or dual interface payment device that includes both a contactless communication interface (e.g., RFID IC, NFC, etc.) and a contact interface (e.g., magnetic stripe, conductive contacts, etc.). A dual interface payment device may have the multi-account payment identifier stored in the magnetic stripe, a memory component of the payment device, and a combination thereof. In some embodiments, a contactless payment device having a multi-account payment identifier representation stored therein may include a display. The display may include one or more display technologies such as, for example, light emitting diodes, a thin film display, a liquid crystal display, an active-matrix organic light-emitting diode display, an organic light-emitting diode display, and others. In some embodiments, the multi-account payment identifier may be presented in the display.

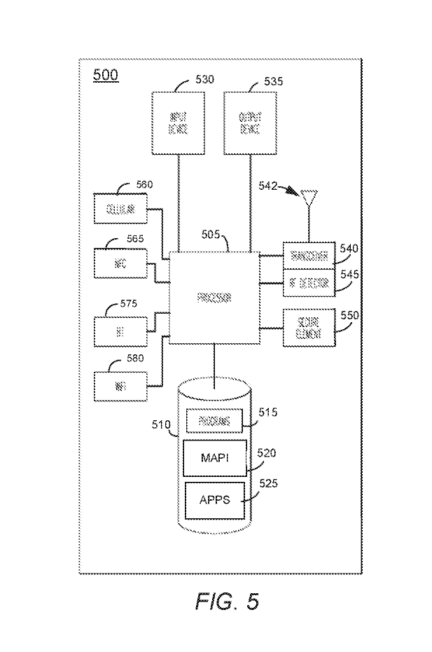

In some aspects herein, embodiments of a payment device may be embodied in an application, app, program, a browser (or browser-enabled application, extension, or add-on, and service), non-transitory computer-readable instructions and the like executing on a mobile device, and a device having a processor to execute an application or program instructions. In some aspects, such devices may be said to be encompassed by disclosures herein referring to a “mobile device” or a “smartphone” even where such an electronic device may not necessarily be easily transported (e.g., a desktop PC). In some aspects, the mobile device may be a device including telephony functionality and implemented as any number of different hardware, software, and combination thereof configurations. For example, FIG. 5 is a block diagram of an apparatus, device, or system for a multifunctional mobile device 500 including a mobile or cellular telephone capability and a short-range wireless communication capability. FIG. 5 does not imply or necessarily represent a physical layout of the mobile device 500. In its hardware and in some of its software/firmware, the mobile device 500 may be substantially conventional. However, the mobile device 500 may include hardware, software, firmware, and combinations thereof to implement and embody aspects of the present disclosure, including the methods and processes herein.

The mobile device 500 may include a conventional housing (not explicitly shown) that contains and/or supports the other components of the mobile telephone. The housing may, for example, be shaped and sized so as to be held in the user's hand. In some embodiments, the mobile device 500 may be housed in a device such as a tablet computing device and other form factors.

The mobile device 500 may include a processor 505 that processes and controls data in the mobile device that is interfaced with a memory 510 and capable of executing program instructions 515 stored in memory 510, a transceiver 540 for transmitting and receiving communication signals to and from an antenna 542, and a RF detector 545 comprising part of the transceiver for detecting RF signals. Though not separately depicted in FIG. 5, a memory 510 may include or encompass, in various embodiments, RAM, ROM, a SIM card, a solid state drive, flash memory, and other types and forms of data storage devices and media. The processes disclosed herein may be implemented by the components of the mobile device 500. For example, the memory 510 may store a MAPI 520 under the control of processor 505 and programs 525 to effectuate various applications and services. The program instructions, programs, applications, and “apps” described herein and the data used thereby may be stored, at least in part, in a compressed, uncompiled and/or encrypted format.

A transceiver 540 may be coupled to an antenna 542 and connect to the communication channel(s) by which the mobile telephone 500 communicates via a mobile network (not shown). The transceiver 540 is in communication with the antenna 542 that may serve to transmit and receive wireless wide-range and short-range communication signals. The mobile telephone 500 may also include an input device 530 (e.g., a microphone, a keypad, keyboard, touchscreen system, voice input components, etc.) for receiving inputs from a user, and an output device 535 (e.g., a speaker, an indicator light, a display, etc.) for providing an output of the mobile telephone 500 to the user or other entities.

In conventional fashion, the transceiver 540 operates to transmit, via the antenna 542, voice signals received from a user through the input device 530, and operates to reproduce, via the output device 535 (e.g., a speaker), voice signals received via the antenna 542. The transceiver 540 may also further operate to handle transmission and reception of text messages and/or other data communications via the antenna 542. In some embodiments, the mobile telephone 500 may transmit wireless communication signals in any frequency range and power, including those now used and those that may be used in the future without limit.

The mobile telephone 500 may be capable of communicating with another device via cellular telephone signals as provided by a cellular component or module 560 and a variety of short-range communication protocols, such as and by NFC signals as provided by an NFC module or components 565 or the like, Bluetooth® as provided by a Bluetooth® module 575, and/or by a wireless local area network (e.g., Wi-Fi, based on IEEE 802.11 b/g/n or other standards) as provided by a Wi-Fi module 580.

In some embodiments, the mobile telephone 500 may be a NFC-enabled mobile telephone equipped to operate as a secure proximity payment device and interact/communicate with another device (not shown in FIG. 5) such as a ticket kiosk/device and a contactless-POS terminal or other device that may include an RFID tag. In some embodiments, the contactless-POS or other device and mobile telephone 500 may typically be positioned in close proximity of each other when communicating using NFC signals. In some aspects, the contactless-POS or other device and mobile telephone 500 may be within about 0 to 10 millimeters of each other in order for an RF power field generated by either the mobile telephone and the contactless-POS terminal or other device to transfer data there between.

In some embodiments, the methods and processes herein, including the functionality and operation of a mobile device or other wireless communication mobile device in accordance with the methods and processes herein related to a multi-account payment identifier may be included, supplied, or otherwise provisioned with the mobile telephone or other wireless communication mobile device to operate independently of any other features of the mobile telephone or other wireless communication mobile device. In some aspects, at least some aspects of the mobile device's functionality to operate as a payment device may be stored or located in a secure element 550. The configuration of the secure element 550 may be provided in conformance with one or more industry standards.

Regarding a device such as, for example, the mobile device 500 herein, a user or cardholder may obtain an application or functionality for storing and transmitting a multi-account payment identifier with the aid of the mobile device. In one embodiment, the payment device user may download a mobile app from an issuer, an app store or service compatible with the mobile device, or a third party to their mobile device. Once the payment device user is enabled to operate to obtain and store a multi-account identifier, the user may link or otherwise associate their multi-account payment identifier with one or more PANs using, for example, the assistance of an app executing on the mobile device, so that they can include their multi-account payment identifier in a transaction used during an in-store or e-commerce shopping experience.

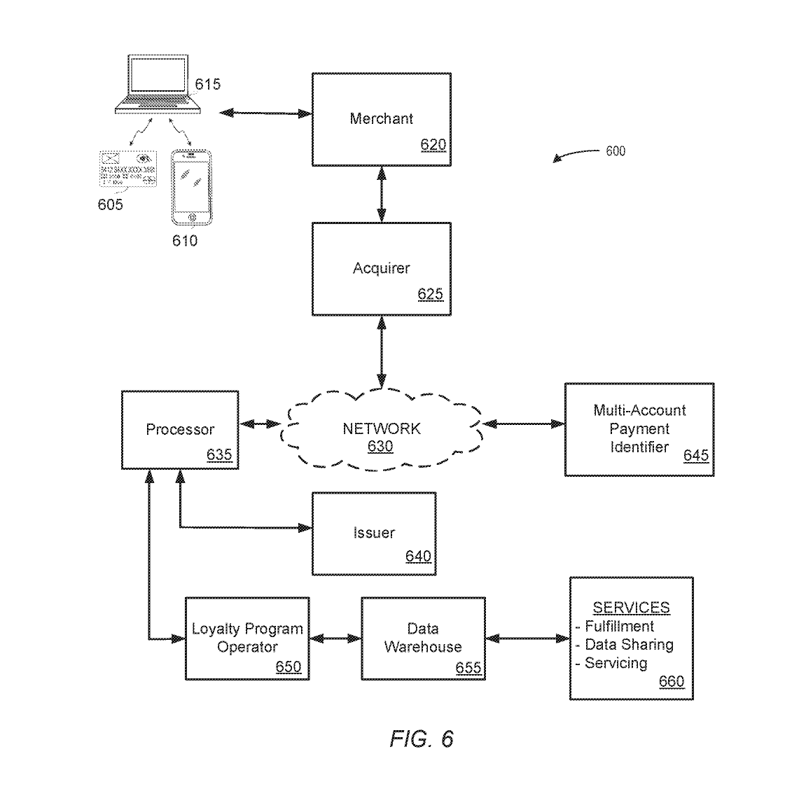

FIG. 6 is a block diagram illustrating a multi-account payment identifier enabled payment device and system 600 according to an embodiment herein. The system 600 may be used to initiate and complete Internet-based, e-commerce, and/or other transactions in accordance with processes described herein. In some aspects, the multi-account payment identifier stored on a mobile device 610 may be automatically entered into an e-commerce shopping cart presence of a merchant 620 presented in an Internet browser on a computing device 615 and in some embodiments the multi-account payment identifier may be entered into the merchant's system via a contact or contactless payment card or device reader (not shown). The computing device 615—which may be a laptop computer, desktop computer, tablet computing device and the like—is connected (wirelessly and/or via cables, such as fiber-optic cable, Wi-Fi, etc.) to the merchant 520. A consumer cardholder or user may provide payment information to the merchant during a checkout at the merchant's e-commerce site. The payment information may include a multi-account payment identifier PAN (or proxy thereof), a security code value (e.g., a CVC), and other information. In some embodiments, the multi-account payment identifier stored on the card 605 and the mobile device 610 may be transmitted to computing device 615 via a contact or contactless reader or entered via a user interface by the user. The user interface may comprise a touchscreen, a keypad, and keyboard, and speaker, and other user input devices.

The payment device or vehicle comprising card 605 may be a portable digital device, such as a payment card, key fob, a chip card, and some other token. In some aspects, the mobile device 610 having a mobile app executing thereon may include a tablet computing device, a multimedia player, a smartwatch, and the like.

Transaction details, including the payment information and the multi-account payment identifier associated with and identifying the user, are transmitted to the merchant 620. The merchant 620 receives the multi-account payment identifier and the payment information and other information (e.g., a card security value). The merchant 620 may forward an authorization request including the received multi-account payment identifier to an acquirer 625. In some aspects, the merchant 620 may generate the transaction request in accordance with industry “standards” governing a purchase transaction including a PAN (e.g., the multi-account payment identifier). An aspect of some embodiments herein includes the inclusion of a multi-account payment identifier value in the authorization request. The multi-account payment identifier is included in the authorization request and may be used, according to some embodiments as an identifier of the user (e.g., cardholder or mobile payment device 610 user).

In accordance with some embodiments herein, the multi-account payment identifier included in the authorization request may be a single value. The multi-account payment identifier may be a string of a plurality of numeric values that is uniquely associated with one entity that serves to accurately authenticate the identity of that entity. The multi-account payment identifier may be appended to a message (e.g., an authorization request) to be routed to a payment network 630.

Referring still to FIG. 6, the authorization request is sent from the merchant 620 to the acquirer 625 who in turn routes the authorization request to the payment network 630. Again, the authorization request may include the multi-account payment identifier value in addition to any other payment credentials received from the merchant.

In some aspects, the payment network operator may, at least, route the authorization request to a payment processor 635 that facilitates processing of payment transactions. In some embodiments, the processor 635 may transmit the authorization request including the multi-account payment identifier to an issuer 640 for authorization (or denial) of the authorization request. The issuer 640 may generate an authorization response in reply to the authorization request that is routed back to the merchant 620 via the payment network 630. In some embodiments, the acquirer 625, the payment network operator, a processor, and the issuer 640 may treat the authorization request including the multi-account payment identifier the same or similar to an authorization request only including a typical PAN from the perspective of processing a purchase transactions' authorization request.

In some aspects, the payment network 630, and more particularly an operator of the payment network, may store the multi-account payment identifier transmitted in the authorization request in a memory device or data store under its control. The multi-account payment identifier may be stored with other information included in the authorization request, such as r transaction details including but not limited to the merchant involved in the transaction, the cost of the transaction, the time and place of the transaction, the details of the item(s) being purchased, etc.

In some embodiments, the payment network operator may determine by a computer or other processor-based machine whether the multi-account payment identifier received thereby is to be associated with one of a number of different payment accounts. For example, the payment network operator may determine that the multi-account payment identifier received in an authorization request in connection with a purchase transaction is to be forwarded to issuer 640 for clearing and settlement purposes using a first PAN. In another example, the payment network operator may determine that the multi-account payment identifier received in an authorization request in connection with a purchase transaction should be processed using a second PAN. According to some embodiments, this decision may be based at least in part on information received from a loyalty program operator 650 that services and manages a loyalty program to which the user of payment device 605, 610 is a registered participant. It may be determined that multi-account payment identifier received in an authorization request (or other messages by other methods) need not be forwarded to the loyalty program operator and others (e.g., because the transaction does not qualify the reward requirements).

In some embodiments, the payment network operator may provide both the multi-account payment identifier and the selected linked-PAN to the issuer 640. The process of routing the PAN to the issuer may be subject to one or more laws, regulations, and applicable industry “standards” that govern how securely the PAN must be stored, transmitted, and processed. As such, handling of the PAN by the issuer 640 may be considered a secure operation given the processes and mechanisms implemented to safeguard the storage, transmission, and processing of the PAN. Given the security measures that may be used regarding the processing of the PAN sent to, for example, the issuer 640, the routing of a multi-account payment identifier along with the PAN may also be considered a secure operation.

In some embodiments herein, the selected payment account may be generated by the payment network provider or another entity at 645. The multi-account payment identifier may be used to select a recommended linked payment account at 645 and provided to the payment network provider at 630. Note that there may or may not be a separation between network 630 and the use of the multi-account payment identifier at 645. A multi-account payment identifier registration process may include associating multi-account payment identifier with a particular user entity and/or associating the multi-account payment identifier with multiple PANs and/or other payment identifiers.

In some embodiments, the payment network operator may provide a potential payment account (associated with the multi-account payment identifier) to a loyalty program operator 650, a data warehouse 655, services 660, and/or other third-party entities. In this way, the loyalty program operator 650 (or any other entity) may return an indication of an amount of reward points, frequent flier miles, etc., that might be associated with the transaction if a particular linked payment account is selected by the card holder. A recommended payment account can then be automatically selected and displayed to the cardholder (who may choose to use the recommended payment account or any other account).

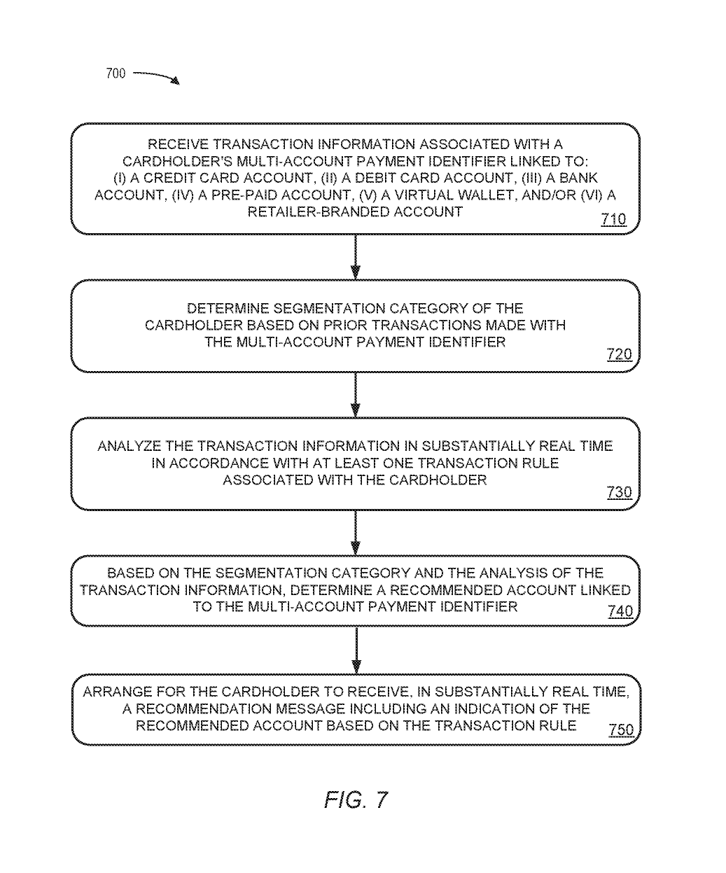

FIG. 7 is an illustrative depiction of a process 700 related to aspects of processing a transaction including a multi-account payment identifier, in accordance with some embodiments herein. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. Further note that some or all of the steps may be “automated.” As used herein, the term “automated” may refer to, for example, actions that can be performed with little or no human intervention.

Note that the method 700 may improve transaction processing over a computer network. For example, by helpfully and automatically recommending the best payment account for a particular transaction, the number of messages exchanged over the network may be reduced (e.g., as a cardholder does not need to investigate which payment account will provide the best rewards, etc.). At 710, the system may receive, via the computer network, electronic messages containing transaction information associated with a cardholder's multi-account payment identifier. The multi-account payment identifier may be, for example, linked to at least two different types of accounts of the following account types: (i) a credit card account, (ii) a debit card account, (iii) a bank account, (iv) a pre-paid account, (v) a virtual wallet, and (vi) a retailer-branded account. According to some embodiments, the transaction information is received from a merchant's POS terminal. Moreover, note that the multi-account payment identifier might be received from, for example, a magnetic stripe of a payment card, a web browser, and/or a smartphone application.

At 720, a multi-account payment identifier platform processor may determine a segmentation category of the cardholder based on prior transactions made with the multi-account payment identifier. For example, segmentation category might indicate that the cardholder is an international traveler, a reluctant card user, etc.

At 730, the transaction information may be analyzed in substantially real time in accordance with at least one potential transaction rule associated with the cardholder. By way of examples only, the transaction rule might be associated with a purchase category, a purchase amount, a rewards program, an availability of funds, and/or a hierarchy. Note that the segmentation category and/or the analysis of the transaction information is based at least in part on transactions not associated with the cardholder (e.g., that are associated with other cardholders). For example, the system might consider what similar consumers, with similar shopping habits, typically due in a particular situation. Further note that the transaction rule might be based at least in part on preference information previously received from the cardholder (e.g., he or she might access a user preference web site to rank his or her accounts in order of preference).

Note that some embodiments described herein involve a “master” card number that can be linked to multiple consumer funding sources including bank accounts/debit cards, major credit cards, prepaid cards, virtual wallets and/or store cards. Instead of carrying multiple cards, the consumer can carry a single card which is linked to several (or even all) of his or her accounts.

Moreover, embodiments may provide a system that allows sets of rules to be defined around those funding sources and purchasing behavior which can be applied at time of purchase or payment. The rules can be pre-defined to apply the desired funding source based on various factors. Note that rules may be combined and/or a hierarchy of rules may be defined. A purchase engine may implement rules connected with a purchase category, such as a type of merchant or purchase (e.g., online, in store etc.). For example, “for all purchases at Merchant X, use my Merchant X card as the primary source,” “for all purchases at grocery stores or gas stations, use credit card Y as the primary source,” or “for online purchases, use my Z account where available.”

A purchase engine may also implement rules connected with a purchase amount. For example, “for purchases over $500, use credit card A” or “for purchases under $25, use a pre-paid card (if funds are available).” As another example, a purchase engine may implement rules connected with rewards (e.g., which source will provide the best rewards for this purchase?). For example, “for a large purchase use my rewards card for each $ spent,” “for travel purchase use my travel rewards credit card,” “for a shopping purchase use my shopping rewards credit card,” and “for purchases under $X, don't consider rewards.”

According to some embodiments, a purchase engine may implement rules connected with an availability of funds (to ensure the funds are available for the purchase). For example, “if funds in source A go below $X, use the next available source” (i.e., when my checking account balance is below $300 put purchases on credit card X), or “if funds needed are not available in the 1st source, use a 2nd source.” According to some embodiments, a purchase engine may implement a payment account hierarchy. For example, “always use my credit card X first, followed by credit card Y,” or “when the primary funding source is declined (e.g., a credit card is declined for a transaction verification hold), automatically go to the next source in the hierarchy I previously defined.

Based on the segmentation category and the analysis of the transaction information at 730, a recommended account linked to the multi-account payment identifier is determined at 740.

It may then be arranged for a recommendation message, including an indication of the recommended account, to be transmitted to the cardholder in substantially real time at 750. According to some embodiments, the recommendation message also includes an indication of a benefit available to the cardholder in connection with the transaction information and at least one of the accounts linked to the multi-account payment identifier. For example, the recommendation message might state that “You Will Get 10,000 Frequent Flier Miles If You Use Card A For This Transaction.” A response to the recommendation message may then be received from the cardholder, and the transaction information can be processed in accordance with the response from the cardholder.

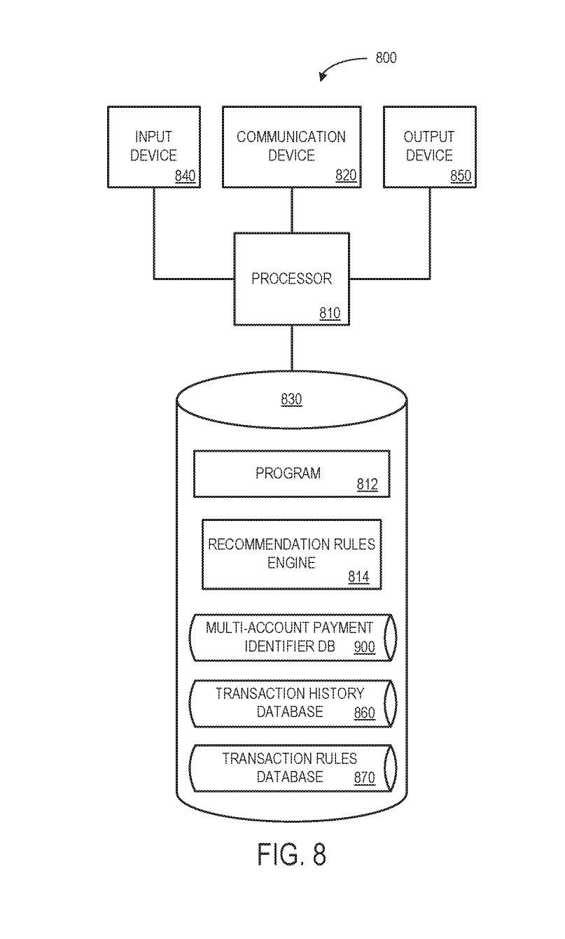

The embodiments described herein may be implemented using any number of different hardware configurations. For example, FIG. 8 illustrates a multi-account payment identifier platform 800 that may be, for example, associated with any of the embodiments described herein. The multi-account payment identifier platform 800 comprises a processor 810, such as one or more commercially available Central Processing Units (CPUs) in the form of one-chip microprocessors, coupled to a communication device 820 configured to communicate via a communication network (not shown in FIG. 8). The multi-account payment identifier platform 800 further includes an input device 840 (e.g., a mouse and/or keyboard to enter recommendation rules configurations) and an output device 850 (e.g., a computer monitor and/or printer to generate reports).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or a recommendation rules engine 814 (e.g., associated with a multi-account payment identifier transaction) for controlling the processor 810. The processor 810 performs instructions of the programs 812, 814, and thereby operates in accordance with any of the embodiments described herein. For example, the processor 810 may receive transaction information associated with a cardholder's multi-account payment identifier, the multi-account payment identifier being linked to: (i) a credit card account, (ii) a debit card account, (iii) a bank account, (iv) a pre-paid account, (v) a virtual wallet, and/or (vi) a retailer-branded account. A segmentation category of the cardholder may be determined based on prior transactions made with the multi-account payment identifier. The transaction information may be analyzed by the processor 810 in substantially real time in accordance with at least one potential transaction rule associated with the cardholder. Based on the segmentation category and the analysis of the transaction information, a recommended account linked to the multi-account payment identifier may be determined by the processor 810, and it may be arranged for a recommendation message, including an indication of the recommended account, to be transmitted from the processor 810 to the cardholder in substantially real time.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the multi-account payment identifier platform 800 from another device; or (ii) a software application or module within the multi-account payment identifier platform 800 from another software application, module, or any other source.

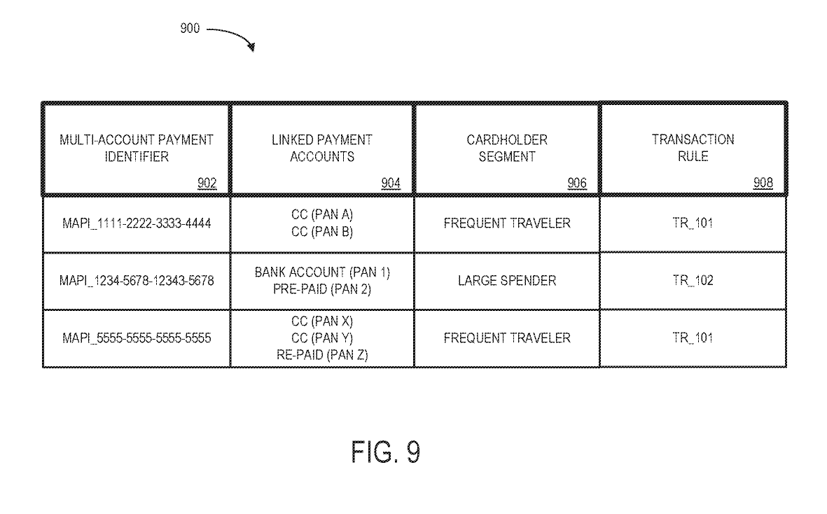

In some embodiments (such as shown in FIG. 8), the storage device 830 further stores a multi-account payment identifier database 900, a transaction history database 860, and a transaction rules database 860. An example of a database that may be used in connection with the multi-account payment identifier platform 800 will now be described in detail with respect to FIG. 9. Note that the databases described herein are only examples, and additional and/or different information may be stored therein. Moreover, various databases might be split or combined in accordance with any of the embodiments described herein.

Referring to FIG. 9, a table is shown that represents the multi-account payment identifier database 900 that may be stored at the multi-account payment identifier platform 800 according to some embodiments. The table may include, for example, entries identifying multi-account payment identifiers associated with various cardholders. The table may also define fields 902, 904, 906, 908 for each of the entries. The fields 902, 904, 906, 908 may, according to some embodiments, specify: a multi-account payment identifier 902, linked payment accounts 904, a cardholder segment 906, and a transaction rule 908. The multi-account payment database 900 may be created and updated, for example, based on information received from cardholder smartphone applications, web interfaces, etc.

The multi-account payment identifier 902 may be, for example, a unique alpha-numeric identifier associated with a master multi-account payment identifier (e.g., a unique PAN). The linked payment accounts 904 may define a set of potential payment accounts linked to the mast multi-account payment account (e.g., credit card accounts, bank accounts, pre-paid accounts, etc.). The cardholder segment 906 may be automatically determined for the cardholder based on past transactions, demographic information (e.g., his or her age), geographic location information, etc. The transaction rule 908 might, for example, point to a record of the transaction rules database 870 that stores the appropriate conditions, input values, business logic, etc. that should be applied in connection with this particular multi-account payment identifier.

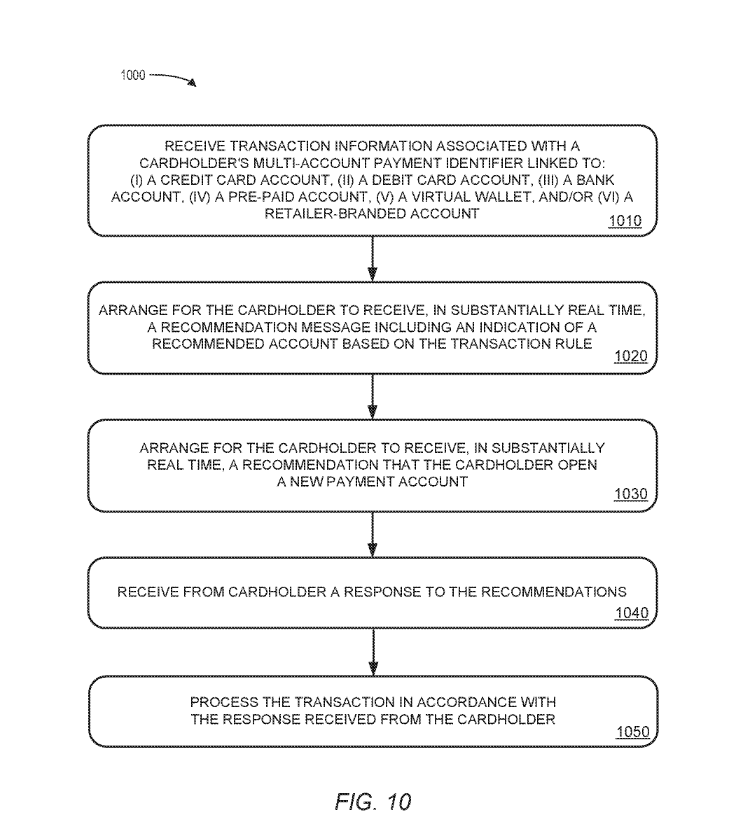

In addition to recommending that an existing payment account (previously linked to a multi-account payment identifier) be used in connection with a particular transaction, some embodiments may suggest that a cardholder open up one or more new payment accounts. For example, FIG. 10 illustrates one example of such an embodiment. At 1010, the system may receive electronic messages containing transaction information associated with a cardholder's multi-account payment identifier. The multi-account payment identifier may be, for example, linked to credit card accounts, debit card accounts, bank accounts, pre-paid accounts, virtual wallets, and/or retailer-branded accounts. According to some embodiments, the transaction information is received from a merchant's POS terminal. A multi-account payment identifier platform processor may determine a segmentation category of the cardholder based on prior transactions made with the multi-account payment identifier, and the transaction information may be analyzed in substantially real time in accordance with at least one potential transaction rule associated with the cardholder. Based on the segmentation category and the analysis of the transaction information, a recommended account linked to the multi-account payment identifier is determined. It may then be arranged for a recommendation message, including an indication of the recommended account, to be transmitted to the cardholder in substantially real time at 1020.

According to some embodiments, the recommendation message may further include a recommendation to open a new payment account at 1030. For example, when a cardholder is signing up for an online movie streaming service, he or she might be told that the first six months of service will be free if he or signs up for a new credit card account. A response to the recommendations may be received from the cardholder at 1040 (e.g., indicating whether he or she is interested in opening a new payment account), and the transaction may be processed in accordance with the received response at 1050.

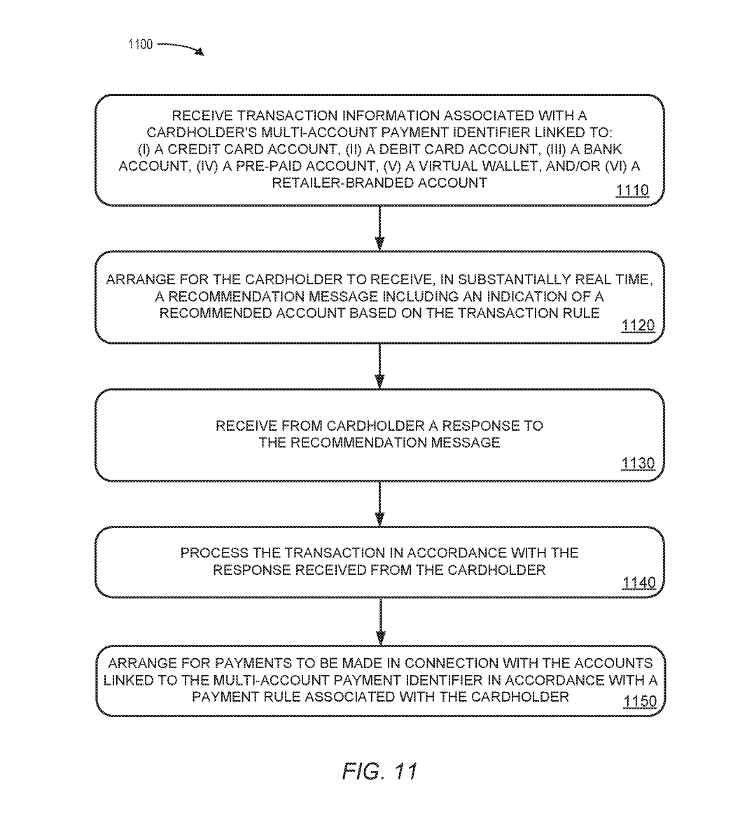

Some embodiments may further facilitate payments made by a cardholder in connection with a multi-account payment identifier. For example, FIG. 11 illustrates one example of such an embodiment. At 1110, the system may receive electronic messages containing transaction information associated with a cardholder's multi-account payment identifier. The multi-account payment identifier may be, for example, linked to credit card accounts, debit card accounts, bank accounts, pre-paid accounts, virtual wallets, and/or retailer-branded accounts. A multi-account payment identifier platform processor may, according to some embodiments, determine a segmentation category of the cardholder based on prior transactions made with the multi-account payment identifier, and the transaction information may be analyzed in substantially real time in accordance with at least one potential transaction rule associated with the cardholder. Based on the segmentation category and the analysis of the transaction information, a recommended account linked to the multi-account payment identifier is determined. It may then be arranged for a recommendation message, including an indication of the recommended account, to be transmitted to the cardholder in substantially real time at 1120.

A response to the recommendations may be received from the cardholder at 1130 (e.g., indicating which linked account should be used for this transaction), and the transaction may be processed in accordance with the received response at 1140.

At 1150, the system may also automatically arrange for payments to be made in connection with accounts linked to the multi-account payment identifier in accordance with a payment rule associated with the cardholder. For example, a cardholder might transmit a payment to the multi-account payment identifier, and these funds would then be applied in accordance with one or more payment rules (e.g., the funds are first to be applied to completely pay off credit card A, and any remaining funds are then to be split 50%-50% between credit card B and credit card C). The payment rules may, according to some embodiments, be associated with payment dates, expected dates of receiving income, dates that bills are due, etc.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A system to improve transaction processing over a computer network, comprising:
(a) a communication port to facilitate receipt of, via the computer network, electronic messages containing transaction information associated with a cardholder's multi-account payment identifier, the multi-account payment identifier being linked to at least two different types of accounts of the following account types: (i) a credit card account, (ii) a debit card account, (iii) a bank account, (iv) a pre-paid account, (v) a virtual wallet, and (vi) a retailer-branded account;
(b) a transaction computer store to store information received in the electronic messages;
(c) a transaction rules computer store to store a set of potential transaction rules; and
(d) a multi-account payment identifier platform processor, coupled to the communication port, the transaction computer store, and the transaction rules computer store, programmed to:
determine a segmentation category of the cardholder based on prior transactions made with the multi-account payment identifier,
analyze the transaction information in substantially real time in accordance with at least one of the potential transaction rules associated with the cardholder,
based on the segmentation category and the analysis of the transaction information, determine a recommended account linked to the multi-account payment identifier, and
arrange for a recommendation message, including an indication of the recommended account, to be transmitted to the cardholder in substantially real time.

2. The system of claim 1, wherein the multi-account payment identifier platform processor is further programmed to:
receive from the cardholder a response to the recommendation message; and
process the transaction information in accordance with the response from the cardholder.

3. The system of claim 1, wherein the recommendation message further includes a recommendation to open a new payment account.

4. The system of claim 1, wherein the recommendation message further includes an indication of a benefit available to the cardholder in connection with the transaction information and at least one of the accounts linked to the multi-account payment identifier.

5. The system of claim 1, wherein at least one of the segmentation category and the analysis of the transaction information is based at least in part on transactions not associated with the cardholder.

6. The system of claim 1, wherein the transaction rule is based at least in part on preference information previously received from the cardholder.

7. The system of claim 1, wherein the multi-account payment identifier platform processor is further programmed to:
arrange for payments to be made in connection with the accounts linked to the multi-account payment identifier in accordance with a payment rule associated with the cardholder.

8. The system of claim 1, wherein the transaction information is received from a merchant's point of sale terminal.

9. The system of claim 1, wherein the transaction rule is associated with at least one of: (i) a purchase category, (ii) a purchase amount, (iii) a rewards program, (iv) an availability of funds, and (v) a hierarchy.

10. The system of claim 1, wherein the multi-account payment identifier is received from at least one of: (i) a magnetic stripe of a payment card, (ii) a web browser, and (iii) a smartphone application.

11. A method to improve transaction processing over a computer network, comprising:
receiving, via the computer network, electronic messages containing transaction information associated with a cardholder's multi-account payment identifier, the multi-account payment identifier being linked to at least two different types of accounts of the following account types: (i) a credit card account, (ii) a debit card account, (iii) a bank account, (iv) a pre-paid account, (v) a virtual wallet, and (vi) a retailer-branded account;
determining, by a multi-account payment identifier platform processor, a segmentation category of the cardholder based on prior transactions made with the multi-account payment identifier;
analyzing the transaction information in substantially real time in accordance with at least one potential transaction rule associated with the cardholder;
based on the segmentation category and the analysis of the transaction information, determining a recommended account linked to the multi-account payment identifier; and
arranging for a recommendation message, including an indication of the recommended account, to be transmitted to the cardholder in substantially real time.

12. The method of claim 10, further comprising:
receiving from the cardholder a response to the recommendation message; and
processing the transaction information in accordance with the response from the cardholder.

13. The method of claim 10, wherein the recommendation message further includes a recommendation to open a new payment account.

14. The method of claim 10, wherein the recommendation message further includes an indication of a benefit available to the cardholder in connection with the transaction information and at least one of the accounts linked to the multi-account payment identifier.

15. The method of claim 10, wherein at least one of the segmentation category and the analysis of the transaction information is based at least in part on transactions not associated with the cardholder.

16. The method of claim 10, wherein the transaction rule is based at least in part on preference information previously received from the cardholder.

17. The method of claim 10, further comprising:
arranging for payments to be made in connection with the at least two different types of accounts in accordance with a payment rule associated with the cardholder.

18. The method of claim 10, wherein the transaction information is received from a merchant's point of sale terminal.

19. The method of claim 10, wherein the transaction rule is associated with at least one of: (i) a purchase category, (ii) a purchase amount, (iii) a rewards program, (iv) an availability of funds, and (v) a hierarchy.

20. The method of claim 10, wherein the multi-account payment identifier is received from at least one of: (i) a magnetic stripe of a payment card, (ii) a web browser, and (iii) a smartphone application.
